(19) United States
(12) Patent Application Publication
(10) Pub. No.: US 2020/0307178 A1
(43) Pub. Date: Oct. 1, 2020

(54) THERMAL CONDUCTIVITY DETERMINATION OF A PRINT MATERIAL

(71) Applicant: Hewlett-Packard Development Company, L.P., Spring, TX (US)

(72) Inventor: Babu N, Bangalore (IN)

(73) Assignee: Hewlett-Packard Development Company, L.P., Spring, TX (US)

(21) Appl. No.: 16/763,243

(22) PCT Filed: Dec. 21, 2017
(86) PCT No.: PCT/US2017/067887

§ 371 Date: May 12, 2020

(51) Int. Cl. B41J 2/045; B41J 2/14

(52) U.S. Cl. CPC B41J 2/0458; B41J 2/14153; B41J 2/04555; B41J 2/04541

(57) ABSTRACT

The present subject matter relates to determination of thermal conductivity of a print material. In an example, a print material ejection system includes a nozzle to eject drops of a print material and a heating element that is to heat the print material when an electric current is supplied to the heating element. The print material ejection system further includes a controller to determine the thermal conductivity of the print material.

### BACKGROUND

Thermal conductivity of a material is a property of the material to conduct heat. Higher the thermal conductivity of a material, greater is the rate of flow of heat across the material. Print material can be defined as a material that is dispensed from a printing system for printing. The print material can be, for example, ink, used for printing on paper, fabric, and the like, and materials that can be used for three-dimensional (3D) printing, such as nanofluid, epoxy resin, binder material, and the like.

### BRIEF DESCRIPTION OF DRAWINGS

The following detailed description references the figures, wherein:

FIG. 1 illustrates a print material ejection system, according to an example implementation of the present subject matter.

FIG. 2 illustrates a print cartridge, according to an example implementation of the present subject matter.

FIG. 3 illustrates a system to measure of thermal conductivity of a print material, according to an example implementation of the present subject matter.

FIG. 4 illustrates a schematic representation of the connection of a heating element with other resistors of a wheatstone bridge, according to an example implementation of the present subject matter.

FIG. 5 illustrates a top view of a heating element and its contact pads, according to an example implementation of the present subject matter.

FIG. 6 illustrates a method for determination of thermal conductivity of a print material in a print material ejection system, according to example implementations of the present subject matter.

### DETAILED DESCRIPTION

Thermal conductivity of a material determines the rate at which a material gets heated when supplied with thermal energy. Therefore, for controlled heating of a material, its thermal conductivity may be first determined to ascertain how much thermal energy is to be supplied to the material. In some applications, print material, such as ink or a material used in producing three-dimensional (3D) structures, is to be heated for ejection of drops of the print material for the printing.

Thermal conductivity of a material may change from time to time due to various factors, such as temperature and composition of the material. Therefore, the thermal conductivity of the material may have changed from the time it was determined initially to the time the material is used in its designated device. For example, thermal conductivity of a print material may be different from a time the thermal conductivity was measured to a time the print material is used in a system for print material ejection.

Generally, thermal conductivity determination is performed using dedicated measurement devices outside the device the material is used in. Therefore, an earlier determined thermal conductivity may be utilized for determining the thermal energy to be transferred to a material in its designated device. Since the thermal conductivity of the material may have changed, the thermal energy transferred to the material in the designated device may be more than or less than the amount of thermal energy that is to be transferred. The transfer of excess thermal energy results in the wastage of energy, while the transfer of lesser thermal energy may cause incomplete heating of the material. For example, if lesser thermal energy is supplied to a print material, the print material may not get ejected for the printing.

The present subject matter relates to determination of thermal conductivity of a print material. With the implementations of the present subject matter, thermal conductivity of a print material can be determined online, i.e., in a system the print material is used in, for example, during use of the system.

In accordance with an example implementation, a print material ejection system includes a nozzle to eject drops of a print material. The print material ejection system may be, for example, a print head. The print material may be, for example, ink or a material used to print 3D structures, such as an epoxy resin, binding material, and a nanofluid. The print material ejection system also includes a circuit having a heating element that is to be in contact with the print material. The heating element is to heat the print material when the heating element is supplied with an electric current. The circuit outputs a signal indicative of a thermal conductivity of the print material when the electric current is supplied to the heating element. A controller determines the thermal conductivity of the print material based on the signal output by the circuit.

In an implementation, the print material ejection system may be part of a print cartridge. The print cartridge includes a reservoir to store the print material. The reservoir is coupled to the print material ejection system to provide the print material to the print material ejection system.

When an alternating electric current (AC current) having a predefined frequency is supplied to the heating element, the heating of the print material causes a voltage across the heating element to include a voltage component having a third harmonic of the predefined frequency. The controller determines the thermal conductivity of the print material based on the voltage component having the third harmonic of the predefined frequency.

The present subject matter enables determination of thermal conductivity of a print material at a print material ejection system in which the print material is used. Therefore, real-time and on-demand determination of thermal conductivity of the print material is achieved. Further, the present subject matter enables detection of a wide range of thermal conductivity values, for example, from 0.1-100 W/m K, and minute changes in thermal conductivity, for example, of the order of 10⁻⁴ W/m K. Further, the thermal conductivity determination can be performed using a small volume, for example, in the range of nanoliters or picoliters, of the print material.

The following description refers to the accompanying drawings. Wherever possible, the same reference numbers are used in the drawings and the following description to refer to the same or similar parts. While several examples are described in the description, modifications, adaptations, and other implementations are possible. Accordingly, the following detailed description does not limit the disclosed examples. Instead, the proper scope of the disclosed examples may be defined by the appended claims.

Example implementations of the present subject matter are described with regard to print materials used in print heads. Although not described, it will be understood that the implementations of the present subject matter can be used to determine thermal conductivity of any material online, i.e., at the device the material is used in.

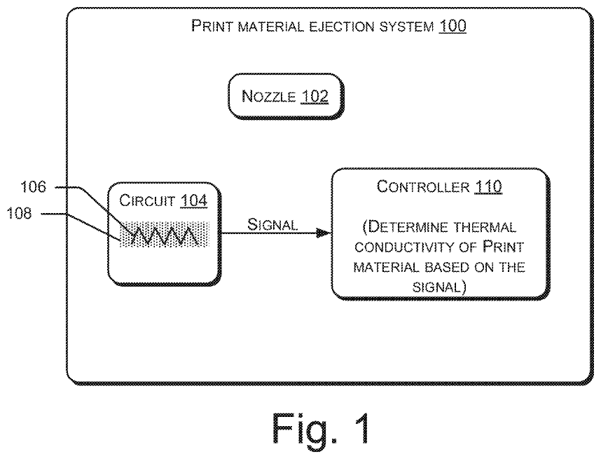

FIG. 1 illustrates a print material ejection system 100, according to an example implementation of the present subject matter. The print material ejection system 100 includes a nozzle 102 to eject drops of print material. Here, the term print material refers to any substance that is dispensed from the print material ejection system 100 for printing (including three-dimensional (3D) printing). In an example, the print material may be ink, used for printing onto a print medium. The print medium can be any type of suitable sheet material, such as paper, card stock, fabric, and the like. In some other examples, the print material may be a print material used for printing 3D structures. Such print material may be, for example, a nanofluid (used for making nano-structures), a binding material (used for binding a powder-like building material), a photopolymer (used in stereolithography), Acrylonitrile Butadiene Styrene (ABS) plastic, Poly Lactic Acid (PLA), nylon, epoxy resin, or the like. Accordingly, in an example, the print material ejection system 100 may be a print head, which can be used for ejecting ink, binding material, photopolymer, nanofluid, and the like.

The print material ejection system 100 also includes a circuit 104 that can be used for determining thermal conductivity of the print material. The circuit 104 includes a heating element 106. In an example, the heating element 106 may be a thermal resistor formed of a dual metal layer metal plate, such as aluminum-copper (AlCu), tantalum-aluminum (TaAl), AlCu on TaAl, or AlCu on tungsten silicon nitride (WSiN). The heating element 106 may be in contact with the print material, represented by the reference numeral 108. The heating element 106 can be supplied with an electric current for heating the print material 108. The electric current causes heating of the heating element 106, which, in turn, causes the heating of the print material 108.

When the heating element 106 is supplied with the electric current, due to the heating of the print material 108, the circuit 104 outputs a signal that is indicative of the thermal conductivity of the print material 108. A controller 110 of the print material ejection system 100 can determine the thermal conductivity of the print material 108 based on the signal output by the circuit 104.

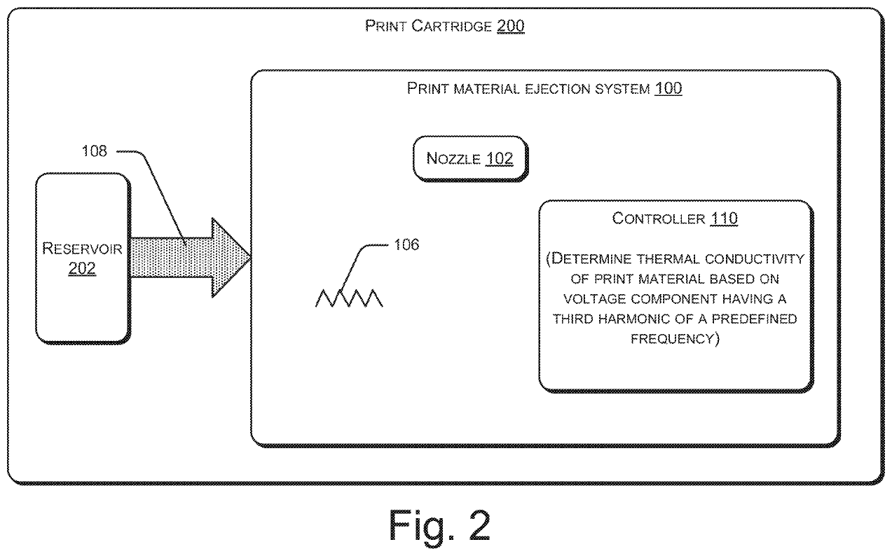

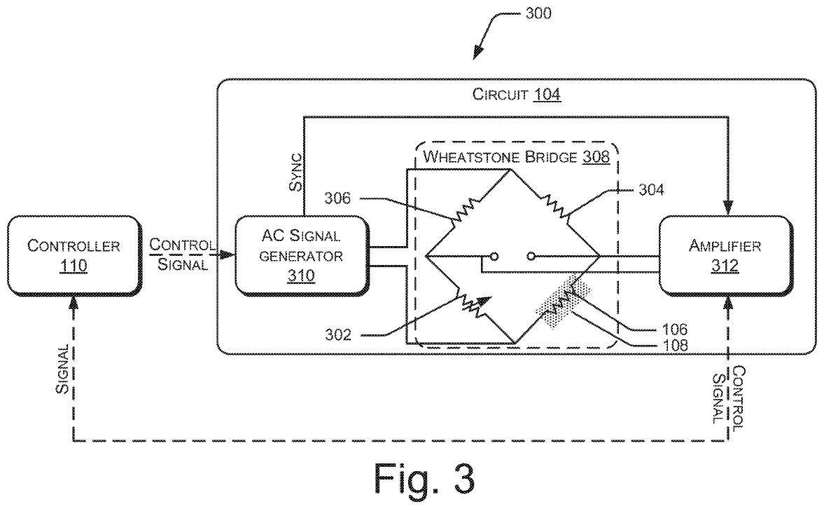

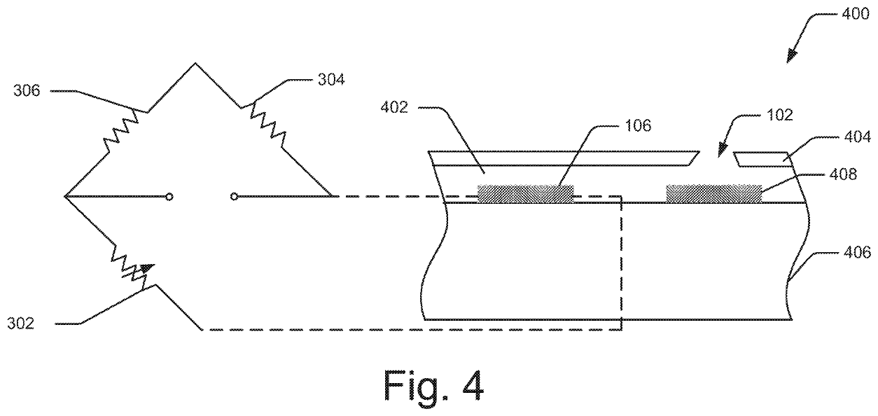

The various components of the circuit 104 and the determination of the thermal conductivity of the print material 108 will be explained in greater detail with reference to FIGS. 3-4. The print material ejection system 100 can be used in a print cartridge, as will be explained with reference to FIG. 2.

FIG. 2 illustrates a print cartridge 200, according to an example implementation of the present subject matter. The print cartridge 200 is more generally a print material-jet precision-dispensing device or print material ejector structure that precisely dispenses a print material, such as the print material 108. In an example, the print cartridge 200 may be a single or multi-color ink cartridge for an inkjet printer. In another example, the print cartridge 200 may be a 3D print cartridge.

While the present description describes generally an inkjet print cartridge that ejects ink onto media, examples of the present specification may not be limited to inkjet print cartridges alone. In general, examples of the present specification may be applied to any type of print material-jet precision-dispensing devices that dispense a print material. A print material-jet precision-dispensing device is one that can precisely dispense the print material in a jet-like manner. Accordingly, the print cartridge 200 may be a 3D print cartridge that can dispense print material that can be used for printing 3D structures.

The print cartridge 200 includes a reservoir 202 to store the print material 108 and the print material ejection system 100 that is coupled to the reservoir 202. The print material ejection system 100 can receive the print material 108 stored in the reservoir 202. The print material ejection system 100, then, can eject drops of the print material through nozzles, such as the nozzle 102.

The print material ejection system 100 includes the heating element 106. As explained earlier, the heating element 106 can heat the print material 108 when an electric current is supplied to the heating element 106. For enabling heating of the print material 108 by the heating element 106, a small amount of the print material 108 may be supplied to the heating element 106, so that the heating element 106 can remain immersed in the print material 108. The print material 108 may be supplied through microfluidic channels (not shown in FIG. 2) provided in the print cartridge 200.

When an Alternating electric current (AC current) having a predefined frequency is supplied to the heating element 106, due to the heating of the print material 108, the voltage across the heating element 106 includes a voltage component having a third harmonic of the predefined frequency. For example, if the frequency of the AC current is w, the voltage across the heating element 106 includes a third harmonic component, i.e., having a frequency of 3ω, as will be explained below.

When the AC current ‘I’, having the frequency ω, is supplied to the heating element 106 having a resistance ‘R’, a joule heating I²R is caused, which has a frequency of 2ω. This heating causes a thermal wave at the frequency of 2ω, which penetrates the print material 108, surrounding the heating element 106. This causes temperature oscillations in the heating element 106. The amplitude and phase lag of the temperature oscillations depend on the thermal conductivity of the print material 108. The temperature oscillations cause the resistance of the heating element 106 to have a component that oscillates at 2ω due to variation of the resistance with temperature. The resistance, when multiplied by the electric current, having the frequency ω, causes a voltage across the heating element 106 to include a component having a third harmonic of the predefined frequency, i.e., a frequency of 3ω. Since the temperature oscillations in the heating element 106 depends on the thermal conductivity of the print material 108, the third harmonic component of the voltage is indicative of the thermal conductivity of the print material 108. The technique of using the third harmonic component of the voltage to determine the thermal conductivity is generally known as 3ω technique.

The print material ejection system 100 further includes the controller 110 that can determine the thermal conductivity of the print material 108 based on the voltage component having the third harmonic component of the predefined frequency. The determination of the thermal conductivity of the print material 108 will be explained in greater detail with reference to FIG. 3.

FIG. 3 illustrates a system 300 used for measurement of the thermal conductivity of the print material 108, according to an example implementation of the present subject matter. The system 300 may be incorporated in the print material ejection system 100, thereby enabling thermal conductivity determination at the print material ejection system 100 itself. The determination of the thermal conductivity of the print material 108 while it is in the print material ejection system 100 is referred to as online determination of the thermal conductivity, as, here, a sample of the print material 108 is not taken offline for the thermal conductivity determination. Thus, the online thermal conductivity determination facilitates on-demand and real-time determination of the thermal conductivity of the print material 108.

The system 300 includes the circuit 104 and the controller 110. The controller 110 may be, for example, field-programmable gate array (FPGA), microcontroller, microprocessor, or the like. The circuit 104 includes the heating element 106. As illustrated and as explained earlier, the heating element 106 may be in contact with the print material 108. In addition to the heating element 106, the circuit 104 also includes a plurality of resistors. For example, the circuit 104 includes resistors 302, 304, and 306. One of the resistors, resistor 302, is a variable resistor, and may be referred to as the variable resistor 302. The heating element 106 and the resistors 302, 304, and 306 are connected to form a wheatstone bridge 308. For example, as illustrated, the heating element 106 is connected through its two terminals to the resistors 302 and 304. Further, the resistors 302 and 304 are connected to the resistor 306. The resistors 302, 304, and 306 may have a small temperature coefficient of resistance to prevent generation of third harmonic voltage that might add to the voltage component across the heating element 106 having the third harmonic of the predefined frequency.

The circuit 104 includes an AC signal generator 310 to provide an input AC voltage signal to the wheatstone bridge 308. The AC signal generator 310 may be function generator of low total harmonic distortion (THD) that can generate sine waves. The input AC voltage signal may be provided at the terminals of the heating element 106 and the resistor 304 that are unconnected to each other, as illustrated.

The input AC voltage signal causes the heating element 106 to be supplied with the AC current. As explained earlier, the AC current causes a voltage across the heating element 106 to have a third harmonic component, hereinafter referred to as V_{3ω}. Since the heating element 106 is the single resistor in the wheatstone bridge 308 that generates the third harmonic component, by varying the resistance of the variable resistor 304, the wheatstone bridge 308 is balanced, such that the fundamental component of the voltage, V_{w}, is suppressed without affecting the third harmonic component V_{3ω}. An output voltage signal W_{3ω} of the wheatstone bridge 308 is related to the third harmonic component of voltage (V_{3ω}) across the heating element 106 as below:

$${V}_{3 ω} = \frac{{R}_{304} + {R}_{106}}{{R}_{304}} \times {W}_{3 ω}$$

where R₃₀₄ and R₁₀₆ are the resistances of the resistor 304 and the heating element 106, respectively.

As will be understood, the output voltage signal W_{3ω} of the wheatstone bridge 308 is indicative of V_{3ω}, the voltage component across the heating element 106 having the third harmonic of the predefined frequency. The output voltage signal of the wheatstone bridge 308 can be provided to an amplifier 312 of the circuit 104 for amplifying the output voltage signal W_{3ω}. The amplifier 312 may be, for example, a lock-in amplifier, which can accurately measure amplitude and phase of very small magnitude voltage signals. The amplified output voltage signal W_{3ω}, which is the signal output by the circuit 104, is provided to the controller 110. As will be understood, the signal output by the circuit 104 is indicative of the thermal conductivity of the print material 108, and therefore, can be used by the controller 110 to determine the thermal conductivity of the print material 108.

Although the thermal conductivity is explained as being determined with the help of the wheatstone bridge 308, in some examples, thermal conductivity determination can be performed without using the wheatstone bridge 308. For this, the third harmonic component V_{3ω} across the heating element 106 may be determined without using the wheatstone bridge 308.

The AC signal generator 310 may provide a synchronizing signal, Sync, that can be used by the amplifier 312 as a reference signal. The controller 110 can provide a control signal to the AC signal generator 310 for triggering AC signal generator 310. The controller 110 may also provide another control signal to the amplifier 312 for phase detection.

In an example, the print material ejection system 100 can include a plurality of heating elements, similar to the heating element 106. Each heating element can be supplied with energy through electric current to heat the print material 108 surrounding the heating element. Not all heating elements of the print material ejection system 100 may be part of a circuit, such as the circuit 104, that is used for determining thermal conductivity of the print material 108. Such heating elements in the print material ejection system 100 that are not part of the circuit, but used for heating and ejection of drops of the print material 108 are referred to as second heating elements. Each second heating element may have an associated nozzle through which drops of the print material 108 can be ejected when energy is supplied to the second heating element. Further, the print material ejection system 100 can include other heating elements that are part of a circuit like the circuit 104 for the thermal conductivity determination.

In an example, the controller 110 can determine the amount of energy to be supplied to the heating elements for ejection of drops of the print material 108 based on the thermal conductivity of the print material 108. For example, if the thermal conductivity of the print material 108 is high, the controller 110 can determine that a lesser amount of energy is sufficient for ejection of drops of the print material 108. Conversely, if the thermal conductivity of the print material 108 is low, the controller 110 can determine that more amount of energy is to be supplied for ejection of drops of the print material 108. Based on energy determined, the controller 110 can determine the amount of current to be supplied to the second heating elements and/or the time for which an amount of current is to be supplied to the second heating elements for ejection of the drops. The controller 110 can then adjust the amount of current or the time for which the current is to be supplied based on the determined thermal conductivity. The adjustment of the current or the time is also referred to as the adjustment of the energy supplied to the print material 108.

The determination of the thermal conductivity and adjustment of the energy supplied to the second heating elements based on the determined thermal conductivity may be referred to as the calibration of the print material ejection system 100. Calibration of the print material ejection system 100 ensures that excess energy is not supplied to the second heating elements. This can reduce the power consumption of the print material ejection system 100 and can increase the lifetime of the second heating elements, as they are not supplied with excessive amount of energy. Calibration also ensures that lesser amount of energy is not supplied. This ensures complete melting of the print material 108, thereby improving quality of the print. In the case of 3D printing, the complete melting of the print material 108 enables bonding of the print material 108 after ejection, which ensures that the 3D structure printed is free of any defects due to incomplete melting of the print material 108.

In an example, the thermal conductivity determination may be performed periodically. This ensures that the variation of the thermal conductivity of the print material 108 over a period of time due to, for example, loss of moisture, pH drift, loss of dispersion, or change in temperature is captured.

The thermal conductivity determination may also be performed when a new print material or a new batch of print material is refilled in the reservoir 202. For example, for printing nanostructures, nanofluids (fluids having particles with size in a range of a few nanometers) may be filled in the reservoir 202. The filled nanofluid may have different properties, such as particle, base fluid, particle concentration, particle shape, particle size, or surfactants, as compared to an earlier nanofluid in the reservoir 202. Therefore, the filled nanofluid may have a different thermal conductivity than the earlier filled nanofluid. In another example, for printing polymer-based structures, polymers may be heated and ejected out of the print material ejection system 100. Polymers of different compositions may be heated and ejected at different times, and each polymer may have a different thermal conductivity. Therefore, the determination of the thermal conductivity each time a new print material or a new batch of the print material is used ensures that the determined thermal conductivity is up-to-date. For printing of a 3D structure, in an example, the thermal conductivity determination may be performed each time the printing of a new layer of the 3D structure is initiated.

The determination of thermal conductivity of the print material 108 periodically and/or upon change of the print material, combined with the calibration of the print material ejection system 100 based on the determined thermal conductivity, provides superior quality printing, lesser power consumption, and longer lifetime of the heating element 106.

FIG. 4 illustrates a schematic representation of the connection of the heating element 106 with the other resistors of the wheatstone bridge 308, according to an example implementation of the present subject matter.

The heating element 106 may be disposed in a drop generator 400 of the print material ejection system 100. The drop generator 400 may include the nozzle 102 and a print material chamber 402 in which the heating element 106 is disposed. The nozzle 102 may be formed in a nozzle layer 404. The heating element 106 may be formed on a top surface of a substrate 406, such as a silicon substrate. Between the substrate 406 and the heating element 106, an insulating layer (not shown in FIG. 4) may be present. The insulating layer may be made of, for example, phosphosilicate glass (PSG), undoped silicate glass (USG), borophosphosilicate glass (BPSG), or a combination thereof. A passivation layer (not shown in FIG. 4) may be formed over the heating element 106 for preventing corrosion of the heating element 106.

During operation, a thin layer of the print material 108 (not shown in FIG. 4) comes into contact with the heating element 106 or a passivation layer coating of the heating element 106. An electric current may be supplied to the heating element 106 resulting in heating of the heating element 106. This causes the thin layer of the print material 108 to get heated. As explained earlier, the heating of the print material 108 causes a voltage across the heating element 106 to include a component having a third harmonic predefined frequency. Further, as explained earlier, the heating element 106 may be connected to the resistors 302 and 304 to form the wheatstone bridge 308. The output voltage of the wheatstone bridge 308 is indicative of the voltage having the third harmonic predefined frequency, thereby enabling thermal conductivity determination.

For determining the thermal conductivity of the print material 108, the amount of electric current supplied to the heating element 106 may be so adjusted that the print material 108 near the heating element 106 exists in a fluid state, and does not get vaporized. This ensures that the thermal wave can travel through the print material 108.

Further, as explained earlier, the print material ejection system 100 includes a plurality of second heating elements, such as a second heating element 408, for heating and ejection of drops of the print material 108. The second heating element 408 may have an associated nozzle, such as the nozzle 102, through which drops of the heated print material 108 can be ejected. When an electric current is supplied to the second heating element 408, a vapor bubble is created in the print material chamber 402. The rapidly expanding vapor bubble may then drop out of the nozzle 102. When the second heating element 408 cools, the vapor bubble may quickly collapse, drawing more print material 108 into the print material chamber 402. As mentioned earlier, the print material 108 may be supplied to the print material chamber 402 through a microfluidic channel (not shown in FIG. 4) present in the print material ejection system 100. In an example, the various components of the print material ejection system 100, such as the microfluidic channel, print material chamber 402, and nozzle 102 are micro-electro-mechanical systems (MEMS)-based structures.

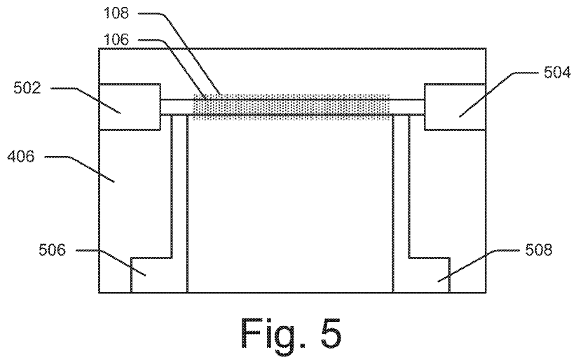

FIG. 5 illustrates a top view of the heating element 106 and its contact pads, according to an example implementation of the present subject matter. As explained earlier, the heating element 106 may be formed on the substrate 406. Further, the print material 108 may be present near the heating element 106. The print material 108 may be made to flow near the heating element 106 by the microfluidic channel in the print material ejection system 100. The heating element 106 may be connected to other components, such as the resistors 302 and 304, the AC signal generator 310, and the amplifier, using one or more contact pads. The contact pads may include contact pads 502, 504, 506, and 508. In an example, when the circuit 104 does not include the wheatstone bridge 308, i.e., the third harmonic component V& is measured without using the wheatstone bridge 308, the AC signal generator 310 may be connected to the heating element 106 through the contact pads 502 and 504, and the output voltage of the heating element 106 can be obtained from the contact pads 506 and 508 for the thermal conductivity determination. In another example, when the circuit 104 includes the wheatstone bridge 308, the heating element 106 may be connected to the contact pads 502 and 504 alone.

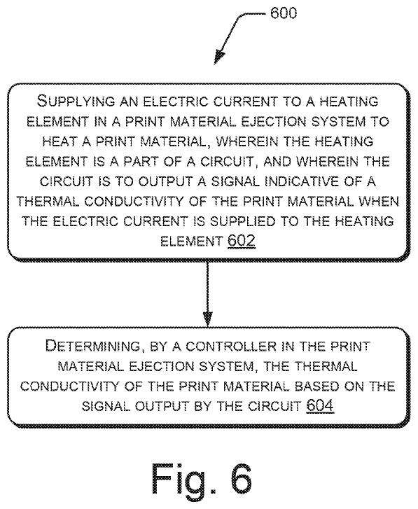

FIG. 6 illustrates a method 600 for determination of thermal conductivity of a print material in a print material ejection system, according to example implementations of the present subject matter.

The order in which the method 600 is described is not intended to be construed as a limitation, and any number of the described method blocks may be combined in any order to implement the method 600, or alternative methods. Furthermore, the method 600 may be implemented by processor(s) or computing device(s) through any suitable hardware, non-transitory machine-readable instructions, or combination thereof. Although the method 600 may be implemented in a variety of systems, the method 600 is explained in relation to the aforementioned print material ejection system 100, for ease of explanation.

At block 602, an electric current is supplied to a heating element in a print material ejection system to heat a print material. The print material ejection system may be, for example, the print material ejection system 100, and the heating element and the print material may be, the heating element 106 and the print material 108, respectively. The print material ejection system may be a print head. The heating element may be a part of a circuit, such as the circuit 104.

The circuit may include a plurality of resistors, such as the resistors 302, 304, and 306. The plurality of resistors and the heating element 106 may be connected to form a wheatstone bridge, which can provide an output voltage signal, such as the signal W_{3ω}. The circuit further includes an AC signal generator, such as the AC signal generator 310 to provide an input AC voltage signal to the wheatstone bridge and an amplifier, such as the amplifier 312, to amplify the output voltage signal.

The circuit is to output a signal indicative of a thermal conductivity of the print material when the electric current is supplied to the heating element. The signal may be, for example, the amplified signal provided by the amplifier. The supply of the electric current to the heating element may be governed by a controller, such as the controller 110, in the print material ejection system.

At block 604, the thermal conductivity of the print material is determined based on the signal output by the circuit. The determination of the thermal conductivity may be performed by the controller.

In an example, the method 600 includes calibration of the print material ejection system by the controller. As explained earlier, calibration of the print material ejection system refers to the determination of thermal conductivity of a print material and adjustment of the energy supplied to the second heating elements based on the determination.

The present subject matter enables online determination of thermal conductivity of print materials. Therefore, real-time and on-demand thermal conductivity determination can be performed. Also, the thermal conductivity values of a wide range can be determined and the determined thermal conductivity is of a high accuracy. Further, the calibration of print material ejection systems based on the determined thermal conductivity provides a superior quality print and efficient technique of printing. The techniques of the present subject matter can be used for various types of printing, such as printing onto a print medium and 3D printing.

Although implementations of thermal conductivity determination of a print material have been described in language specific to structural features and/or methods, it is to be understood that the present subject matter is not necessarily limited to the specific features or methods described. Rather, the specific features and methods are disclosed and explained as example implementations.

We claim:

1. A print material ejection system comprising:
a nozzle to eject drops of a print material;
a circuit comprising a heating element, wherein the heating element is to be in contact with the print material and is to heat the print material when an electric current is supplied to the heating element, and wherein the circuit is to output a signal indicative of a thermal conductivity of the print material when the electric current is supplied to the heating element; and
a controller to determine the thermal conductivity of the print material based on the signal output by the circuit.

2. The print material ejection system of claim 1, wherein the circuit comprises a plurality of resistors, wherein the heating element and the plurality of resistors are connected to form a wheatstone bridge, and wherein the wheatstone bridge is to provide an output voltage signal.

3. The print material ejection system of claim 2, wherein the circuit further comprises:
an Alternating Current (AC) signal generator to provide an input AC voltage signal to the wheatstone bridge; and
an amplifier to amplify the output voltage signal, the amplified output voltage signal being the signal output by the circuit.

4. The print material ejection system of claim 1, wherein the controller is further to determine energy to be supplied for ejection of the drops of the print material based on the thermal conductivity of the print material and adjust the energy supplied based on the determination.

5. The print material ejection system of claim 1, wherein the print material ejection system is a print head.

6. The print material ejection system of claim 1, wherein the print material is one of an ink, a nanofluid, a binding material, a photopolymer, Acrylonitrile Butadiene Styrene (ABS) plastic, Poly Lactic Acid (PLA), nylon, and epoxy resin.

7. A print cartridge comprising:
a reservoir to store a print material; and
a print material ejection system coupled to the reservoir to receive the print material, the print material ejection system comprising:
a nozzle to eject drops of the print material;
a heating element to heat the print material when an electric current is supplied to the heating element, wherein when an Alternating electric current (AC current) having a predefined frequency is supplied to the heating element, the heating of the print material is to cause a voltage across the heating element to comprise a voltage component having a third harmonic of the predefined frequency; and
a controller to determine the thermal conductivity of the print material based on the voltage component having the third harmonic of the predefined frequency.

8. The print cartridge of claim 7, wherein the heating element is a part of a circuit and wherein the circuit further comprises:
a plurality of resistors, wherein the plurality of resistors and the heating element are connected to form a wheatstone bridge, wherein the wheatstone bridge is to provide an output voltage signal indicative of the voltage component having the third harmonic of the predefined frequency;
an Alternating Current (AC) signal generator to provide an input AC voltage signal to the wheatstone bridge; and
an amplifier to amplify the output voltage signal.

9. The print cartridge of claim 7, wherein the print material ejection system is a print head.

10. The print cartridge of claim 7, comprising a plurality of second heating elements for heating the print material for ejection of the drops of the print material.

11. The print cartridge of claim 7, wherein the controller is further to determine energy to be supplied for ejection of the drops of the print material based on the thermal conductivity of the print material and adjust the energy supplied based on the determination.

12. A method comprising:
supplying an electric current to a heating element in a print material ejection system to heat a print material, wherein the heating element is a part of a circuit, and wherein the circuit is to output a signal indicative of a thermal conductivity of the print material when the electric current is supplied to the heating element; and
determining, by a controller in the print material ejection system, the thermal conductivity of the print material based on the signal output by the circuit.

13. The method of claim 12, wherein the circuit further comprises:
a plurality of resistors, wherein the plurality of resistors and the heating element are connected to form a wheatstone bridge, wherein the wheatstone bridge is to provide an output voltage signal;
an Alternating Current (AC) signal generator to provide an input AC voltage signal to the wheatstone bridge; and
an amplifier to amplify the output voltage signal, the amplified voltage signal being the signal output by the circuit.

14. The method of claim 12, comprising calibrating, by the controller, the print material ejection system based on the thermal conductivity of the print material.

15. The method of claim 12, wherein the print material ejection system is a print head.
